(19) United States
(12) Patent Application Publication
(10) Pub. No.: US 2008/0183548 A1
(43) Pub. Date: Jul. 31, 2008

(54) Method for facilitating effective communications among members of an organization

(76) Inventor: Dale Kinsey, Clermont, FL (US)

Correspondence Address: Charles E. Lykes Jr., Suite 101, 501 S. Ft. Harrison Ave., Clearwater, FL, 33756-5348, US

(21) Appl. No.: 11/699,974

(22) Filed: Jan. 29, 2007

(51) Int. Cl. G06F 15/02; G06F 9/46

(52) U.S. Cl. 705/9

(57) ABSTRACT

the invention teaches a method for organizing a pattern of communications within an organization in order to achieve the goal of establishing and maintaining regular contact by and between individual members of an organization and to further allow and facilitate cordial and effective and integrated communication between such individual members and the organizational leadership.

The invention relates to methods for maintaining contact and communication with a church congregation, membership body, civic club or association, affiliated group of business or social members, or other related organization.

### BACKGROUND OF THE INVENTION

A significant matter of concern for voluntary organizations or membership groups, such as churches, civic clubs, political action committees, and other such organizations is the issue of maintaining healthy relationships and communications throughout all levels of membership. The failure to do this results in a lack of interest, collective membership feelings of being “left out”, missed opportunities to fulfill a need or, alternatively, missed opportunities to derive benefits of membership contributions.

It is a simple matter to provide an apparatus, such as a Internet website, telephone tree, publication of a newsletter, or in a variety of communicative methodologies which are capable of sending out current information and providing means of receiving voluntary submissions from organization members concerning their needs and their desire to contribute. Unfortunately, many people will not be effectively reached by such efforts and their potential contributions will be lost. This is for a variety of reasons.

For instance, many people are simply shy or humble and will keep their skills, accomplishments, or problems to themselves. Other people will simply not have the time to take advantage of such publications and to read through them. Others will simply not have a sufficient level of interest without having some level of personal involvement to even be concerned about the availability of such information.

For this reason a variety of methods of achieving the goal of two-way communication up and down all levels of organization in such groups have been attempted. Many of them take advantage of a certain organizational structure while others take advantage of particular kinds of communications methods.

The importance of maintaining a healthy and vibrant flow of communications and information has been the subject of numerous efforts. In U.S. Pat. No. 6,915,270, issued to Young on Jul. 5, 2005, it can be seen that a method for building and maintaining profitable customer relationships is provided. The plan assigns certain aspects of the promotion of customer loyalty, such as ensuring an appropriate level of service, maintaining contact with the customer, delivering information to the customer, and monitoring the level of service and quality to sections within the organization which would be best in position to impact the relationship. In yet another business application, U.S. Pat. No. 6,901,393, issued to Owen on May 30 1, 2005, teaches a means of automating and expediting customer requirements in order to improve the efficiency of delivery of services. The method includes a combination of personal and electronic communication methods. It also includes a process for decision-making. In a similar manner, U.S. Pat. No. 6,859,781, issued to Gloor on Feb. 22, 2005, recognizes the importance of maintaining contact with the customer for the purposes of providing assurance from the organization.

In U.S. Pat. No. 6,850,939, issue to Bostleman on Feb. 1, 2005, it can be seen that it is appropriate to try and maintain or control the levels from which information is disseminated. Accordingly, this disclosure teaches a methodology of managing and selectively controlling the delivery of critical information in order to facilitate the accomplishment of specific tasks and to ensure that they are done at the appropriate level and by the appropriate persons.

For instance, in U.S. Pat. No. 6,996,210, issued to Esty on Feb. 7, 2006, a means of introducing a group of persons with a methodology for operating their organization and stresses the importance of using a program which is shared by the entire group. Accordingly, it can be seen that successful businesses have great concern for the flow and use of information as well as in maintaining effective communication in contact with both members of the organization and members served by the organization.

What is needed but not provided in the prior art is a systematic means of accomplishing the task of maintaining current and energetic communication among members which is reliable, flexible, accommodates such things as special skills and periods of unavailability of key members, and which also serves to stimulate and maintain a high level of personal involvement among membership groups. Also what is not taught in the prior art and which would be useful is a means and methodology which would be applicable when the goal is not one of profit but is one of maintaining cohesion and purpose among a group of persons who share a common goal but who may be very disparate in both means and circumstances and who may have divergent social and recreational interests.

### SUMMARY OF THE INVENTION

The inventor has overcome many of the shortcomings of the prior efforts of achieving the objectives stated above by having formulated a simple but effective means of maintaining the desired level of personal interaction while still allowing control at the higher levels of the organization. In summary, the inventor has achieved this goal by providing a series of circles of communication. Within each circle is comprised a primary and backup contact mechanism which will achieve the goal of ensuring that one or more absentees will not stop the flow of information and which will both enable and insure prompt reporting of difficulties or problems at the higher levels of the organization.

The methodology taught herein is capable of working with very small groups or being expanded to serve a very large congregation or other affiliated group of members. It generally comprises a circle in which each circle comprises a circle leader and circle members. For the purpose of the present invention 12 circle members have been used, but as will be seen, such number may be adjusted to meet the needs of any group. Within each circle the circle members are assigned at least two persons with whom they should maintain contact. Conversely, each circle member has two persons who are assigned the task of maintaining contact with each such member.

Smaller organizations need little more than several circles and means of connecting them with each other to a central control group or person. Larger organizations may well expand into levels of circles and will depend more upon dispersing the appointment of key members throughout the group to ensure that each level is appropriately managed and staffed and that membership assignments remain current and valid.

Although the invention teaches a method, the method should be seen as a scheme which allows and facilitates tailoring in order to achieve specific organizational goals or to “fit” various organizational sizes and types. Even though such tailoring and manipulating are envisioned (and even encouraged), the method taught herein is specific and clear with respect to the steps and process used to achieve the optimal results.

It is, then, an object of the present invention to develop a means of maintaining personal contact with a membership of an organization, such as a church congregation, through all levels of membership.

It is a further object of the present invention to provide such a means of maintaining personal contact which also has built-in alternate and backup means of communication and contact.

It is a further object of the present invention to provide such a means of maintaining personal contact which will facilitate the flow of information to and from and between the highest levels of management and control down to the most basic organizational members.

It is a further object of the present invention to provide such a means of maintaining personal contact which enables adequate control and supervision from the higher managerial levels of an organization but which does not diminish the importance of member to member contact at all levels of the organizational structure.

It is a further object of the present invention to provide such a method which allows enables tailoring to achieve certain specific organizational objectives.

It is a further object of the present invention to provide such a method which allows and enables tailoring to accommodate organizations of various sizes.

It is a further object of the present invention to provide such a method which allows and enables tailoring to accommodate organizations with varied schedules of regular meetings.

It is a further object of the present invention to provide such a method which allows and enables tailoring to accommodate organizations with members of varied levels of participation and interest.

Other features and advantages of the present invention will be apparent from the following description in which the preferred embodiments have been set forth in conjunction with the accompanying drawings.

### BRIEF DESCRIPTION OF THE DRAWINGS

In describing the preferred embodiments of the invention reference will be made to the series of figures and drawings briefly described below. Reference will also be made to certain exhibits useful in describing the operation and practice of the method taught herein.

FIG. 1 is a diagram of a basic membership contact team in which a particular member (Johnson) is shown to have a responsibility to reach two members (Samuels and Moore) and in which two members (Townsend and Dixon) are responsible to reach Johnson.

FIG. 2 is a diagram of a team circle organization in which it can be seen that each member is responsible to reach two members and, conversely, each member is to be reached by two members. A circle leader maintains contact with the entire group.

FIG. 3 is a diagram of connected circles which are organized as a group and a group leader is responsible to coordinate 12 circle leaders. A group leader maintains contact with all circle leaders.

FIG. 4 is a diagram of an organization of connected groups which are organized as a level. A level leader maintains contact with 12 group leaders.

FIG. 5 depicts a circle contact team in which each member reaches out or maintains contact with 4 other members.

While certain drawings have been provided in order to teach the principles and operation of the present invention, it should be understood that, in the detailed description which follows, reference may be made to components or apparatus which are not included in the drawings. Such components and apparatus should be considered as part of the description, even if not included in such a drawing. Likewise, the drawings may include an element, structure, or mechanism which is not described in the textual description of the invention which follows. The invention and description should also be understood to include such a mechanism, component, or element which is depicted in the drawing but not specifically described.

### DETAILED DESCRIPTION OF THE PREFERRED EMBODIMENT

Reference will now be made in detail to the present preferred embodiment of the invention, an example of which is illustrated in the accompanying drawings. While the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the appended claims.

While the following description will seek to improve understanding of the invention by describing the various components and elements, it should be considered that certain apparatus may be sufficiently and adequately explained by the accompanying drawings, which are fully incorporated herein, and not require further description. All such apparatus should be considered as part of the specification of the invention for all purposes.

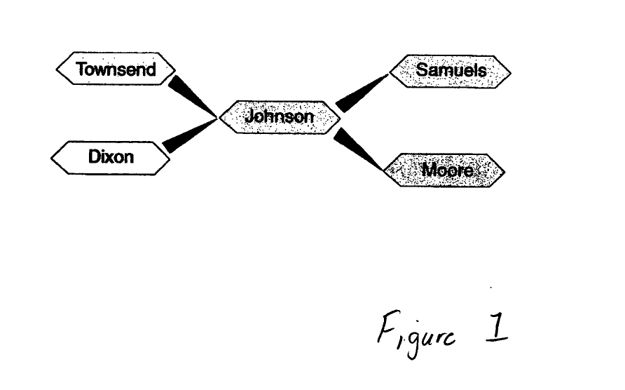

The preferred embodiment of the present invention is taught with respect to its use in maintaining personal contact and involvement of the members of a church organization. Making reference first to FIG. 1 it can be seen that, at the most basic level, the method taught herein both facilitates and depends upon individual organization members establishing and maintaining contact with only a small number of other persons or families. For instance, in FIG. 1 the Johnson family would make a point at short and regular intervals of affirmatively making contact with the Samuels family and the Moore family. Conversely, the Johnson family should expect being contacted at short and regular intervals by the Townsend and Dixon families.

When this method is applied to a church group this could mean each family looking for their designated families at church each week and it could and should also mean making telephone calls during the week, engaging in social activities, or simple home to home visits. Any kind of contact which facilitates and enables the sharing of common concerns of any kind is acceptable. Moreover, when this method is applied to groups other than church groups, which by and large engage in weekly meetings or services, the intervals and kinds of contacts between the members at this basic level may be adjusted or may be designated as being for the purpose of accomplishing or obtaining certain specific items of information.

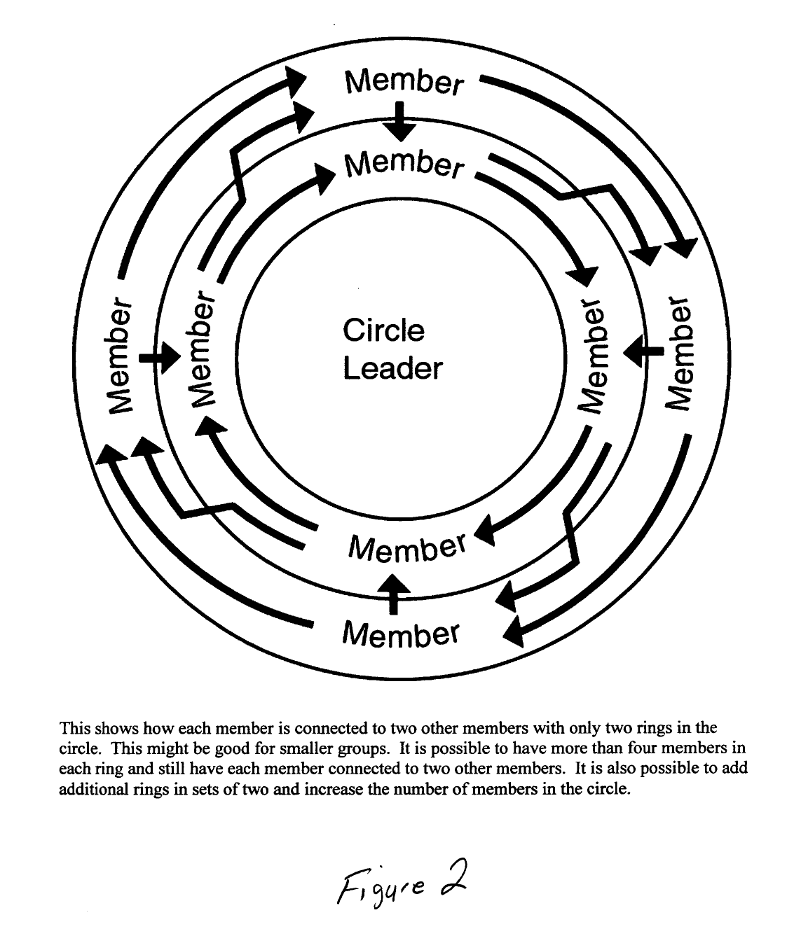

FIG. 2 depicts the basic organizational unit of the scheme which is called a circle. It can be seen that the concept of two members to contact each member and each member to contact two members is very easily programmed in a circle with 12 members. While 12 members seems to be a good number of members for a circle at the church level it should be recognized immediately that such a circle could comprise more or less members depending upon a variety of factors such as the amount of time involved, the reasonable expectations of unit members, the complexity of each contact, and any other factor which may relate to either the desirability or the need for closer contact. This will be developed in greater detail later.

FIG. 2 also depicts that each circle has a circle leader. The circle leader should be picked among those persons to our most apt to devote the time and who have a sense of responsibility. Whereas the basic members will be involved in a closer and more interactive scheme requiring contact to be made with two persons, the circle leader will have the responsibility of, at generally regular but perhaps variable intervals, making contact with each member of the circle. The importance of this is obvious. The circle leader will be the one who will pass information up from the circle to the next level of hierarchy and also who will be responsible for obtaining answers from the higher levels of the organization in order to respond to inquiries are concerns of the members of his or her circle. For instance, in a church setting, the circle leader would be the person to whom such things as serious illnesses, deaths in the family, births in the family, job losses, marital difficulties, or successes such as new jobs are reported so that they may be further reported throughout the institution as appropriate or necessary.

Also, the circle leader should be prepared to deal with such contingencies as individual membership crises of all kinds, the spread of misinformation or rumor, or disillusionment of one or more members with respect to a policy or decision made at high levels. Again, the number 12 seems a manageable and appropriate number for a church but smaller or even larger numbers within a circle could be used as may be appropriate for a given application. The circle leader should always be analyzing the operation of his or her circle in order to ascertain that the necessary and proper contacts are being made.

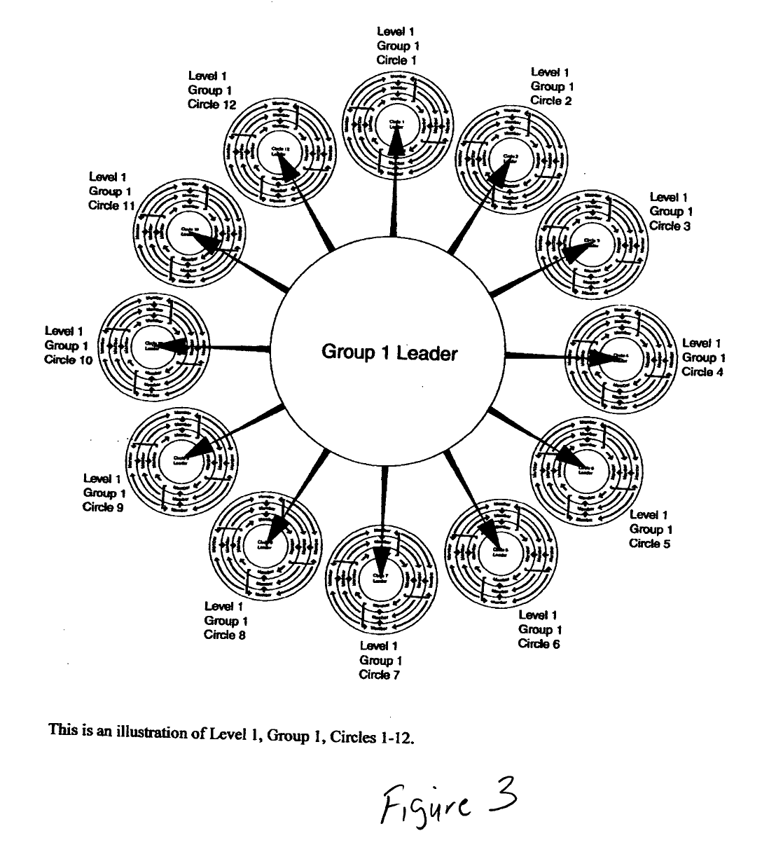

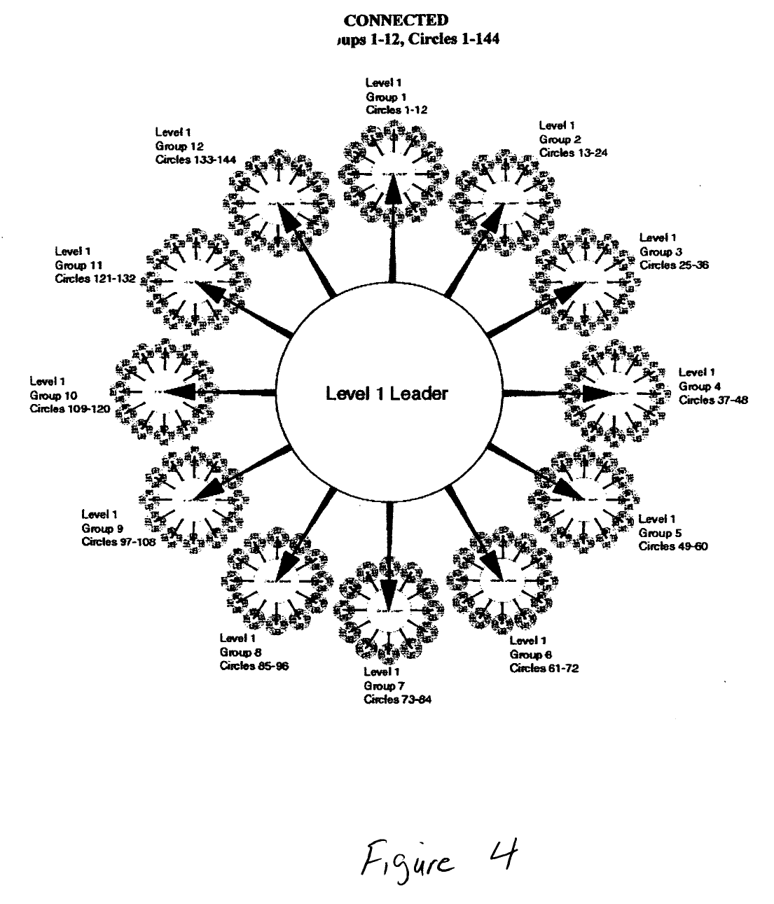

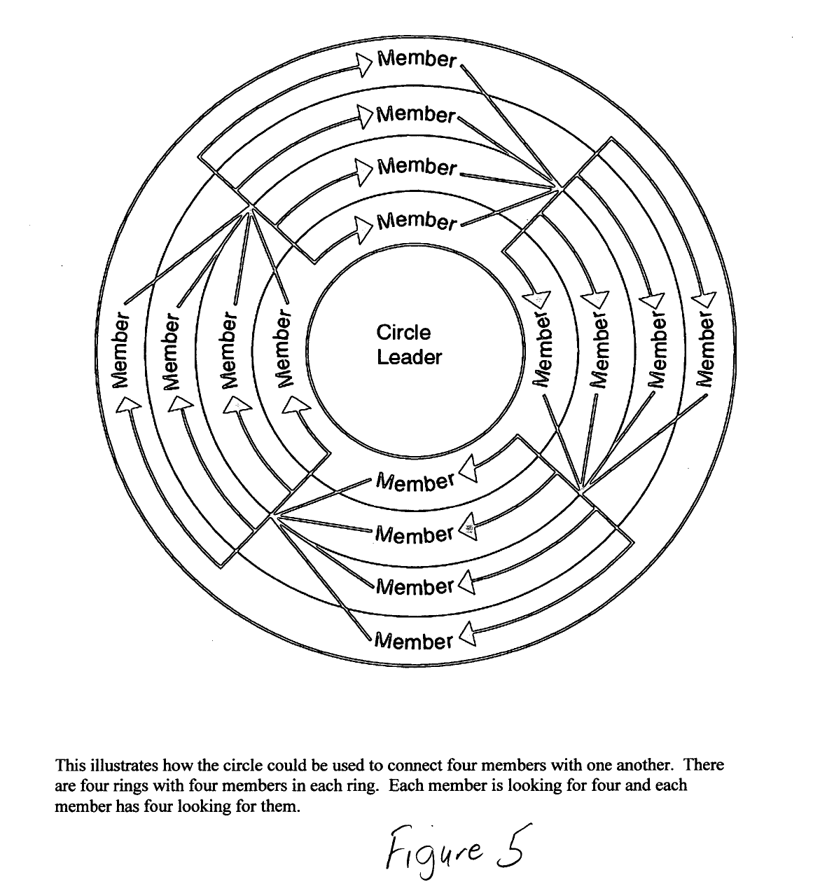

For instance, FIG. 3 depicts a circle with only eight members. It can be seen that the principle of two person contact, both ways, is easily maintained. FIG. 4 depicts a 12 person circle in which only one contact with each member is provided. Using only one contact would save each member's time but would not be as reliable since there would be fewer backup contacts available. Such might be appropriate if the circle group were populated with more diligent persons who would not require backup systems to ensure that all required contacts were made. FIG. 5 depicts a 20 member circle group which comprises four rings of five members each. It can be seen that the dual backup principle is easily applied to a group this large as it was to be smaller 8 member circle. Finally, in FIG. 6, it can be seen that the system could be further adjusted to provide for contact by and between four members each. This arrangement might be made when circumstances indicated that increasing contacts among members would benefit the group for some period of time.

Having discussed the basic membership level of organization, it is now appropriate to discuss the higher levels of membership participation. In doing so the inventor has adopted the use of the terms “group” to represent the next higher level from a “circle” and to further use the term “level” to represent the next higher level from a “group”. These terms are nothing more than a convention as such terms have many common applications in our language. Accordingly, while such terms will be used consistently in order to facilitate and promote the understanding of the invention, it should be noted that any appropriate terminology may be adopted to meet the situation. For instance, a “circle” could just as easily be called a “team” or even a “group”. The members within that organization will use the terms consistently and they will be well understood. The possibilities here are endless. For instance, a voluntary organization of military veterans may adopt the use of such military terms as “team”, “squad”, “platoon”, or “company”.

It is appropriate here to consider that it is a matter of importance to consider the relative skills, abilities, and level of devotion and responsibility for each key appointment or assignment within the plan. Organizations have formulated a variety of evaluation criteria to select leaders at all levels of their organizations. It is not the purpose of this invention to teach a means for the evaluation of the psychological and sociological considerations of such appointments nor for making selections of such persons. It is, however, worth noting that any such system for the management and communication with groups of persons will be dependent upon the selection and appointment of such key personnel. A voluntary organization, such as a church congregation or a service club, will normally have neither the resources nor the desire to engage in cumbersome personnel management processes. Accordingly, one distinct advantage of the disclosure taught herein is that it is readily capable of “fine tuning” or “tweaking” in order to achieve the best results.

For instance, it could be that a very zealous and capable member assigned as a circle leader may suddenly receive a new employment opportunity which may deprive him or her of the ability to fulfill the responsibilities of circle leader. In that case a new circle member may be easily appointed. It may also be that, within a circle, persons assigned to keep in touch with or maintain contact with each other may turn out to have either schedules which don't allow it or personalities which do not facilitate the smooth continuous contact. Accordingly, it would be advisable to have a circle leader who could simply make a required reorientation of the contact pattern to avoid the conflict or, be capable of resolving the issue by some lesser means. It can be seen that the responsibility of circle leader is not without some level of discretion. It can also be seen that the circle leader should be one who will act upon such circumstances in order to prevent a simple scheduling conflict or a more complicated personality conflict from interrupting the flow of communication. If the circle leader can not resolve the issue the issue should be passed up to the next level.

It can also be seen that, as the circle levels increase the population of the group increases exponentially. Accordingly, at the higher levels the group and level members must possess these same basic leadership skills as well as more sophisticated management and organizational skills because of the significantly larger numbers of members falling within their overall responsibility. It is not unreasonable to say that any organization which maintains a schedule of meetings, events, and programs, and grows to a significant size will almost always have a regular staff of full time employees or officers and will also have a cadre of more devoted and zealous members from which these more significant leadership positions may be filled. Just as within the circle, but not with quite as much ease, these leadership positions can also be managed, reassigned, or changed when necessary to accommodate the needs of the organization.

It should also be noted at the outset that, even at the most basic level, this method will almost certainly result in the sharing of all kinds of information between organization members. This will naturally include some very personal and private information. Accordingly, it is important to have a methodology to provide guidance in such matters. For instance, a legal privilege is recognized in many states to exist between a member of the clergy and a passionate person. Accordingly, when such information is to be shared within this framework it is important to have a process for identifying when it may be appropriate for communications to be limited to contact with members of the clergy and when it may be appropriate for certain information to simply remain private between members and not be put into the system information flow. Circle, and group, and level leaders should have special training and guidance in this area and should be selected from those who are particularly trustworthy in such matters.

It is also critical to define those places where formal staff and key members of informal, or lay staff, should be located. While it can be seen that, at each level of the circles, no person is ever responsible to contact more than his or her two assigned members are no leader is ever responsible to maintain contact with more than 12 members, it should also be apparent that in the leadership positions, the areas of concern will become increasingly burdensome and complex. This is because each level leader will be receiving and disseminating data from 12 group leaders who are, in turn, receiving and disseminating data to and from 12 circle leaders who are, in turn, receiving and disseminating data to and from 12 members. Accordingly, there is an exponential level of responsibility, at least for the numbers of persons who may fall under the leadership of each progressive level.

While it has been a goal and objective of the present invention and disclosure to provide a program which administers to the needs of all members of an organization regardless of social status, ethnic group, gender, age, or any other sociological factor, it should also be noted that, as the group gets larger, it may be advantageous to make circle or group assignments based upon such shared conditions as age or retirement status, marital status, recreational interests, or any other criteria which would not result in undermining the organizational integrity but which could be useful in facilitating organizational social activities, delivery of organizational services, or to ministering to common needs and circumstances. For instance, a circle comprising entirely retirees might be very useful in the ability of circle members to assist one another through common challenges. Another organizational means of doing this might be to simply form a program for that purpose which would be apart from the circle connection format. This is another area wherein strategic choices can and should be made by program administrators.

It is anticipated that a very large organization would also have a larger professional staff. These would include full time employees or members who could be counted upon and expected to handle these increasingly great levels of data flow. They will also be people who will be well versed in the workings of the organization and its policies and principles so that they may provide authoritative guidance to such inquiries which may emanate from any level of the membership and migrate up to their level. Such persons will also be capable of making immediate contact with necessary persons and resources, such as pastors, counselors, deacons, program administrators, or others, which may be necessary to either provide help or to answer a specific inquiry.

An advantage of having an established program for accomplishing and facilitating improved relationships among members is that it enables rapid assimilation into the organization of new members and provides an immediate role for them to play. Everyone in the organization will have the responsibility of at least making contact with their own immediate contact members and everyone in the organization will be encouraged and sought out by their own immediate contacting members.

Another advantage is that the methodology is capable of clear and standard explanations. In order to facilitate the effectiveness of the program literature and supporting documents can be devised in order to promote the program. For instance, as can be seen from Exhibit 1, a circle member would receive a small booklet in which his or her role in the organization as a member is explained and the process of making contacts can be facilitated by such things as providing pictures and contact data for each members contact parties and a journal for reminding and recording the contacts and activities. Such a document could also be used to explain more carefully the importance of private information and to list the resources available for specific needs. Such could also be used to provide general policy statements and list regularly scheduled activities.

Exhibit 2 shows how this set of responsibilities expands for the circle leader, Exhibit 3 shows what they might mean for a group leader, and Exhibit 4 shows what may be in store for a level leader. Also incorporated into this disclosure as Exhibit 5 is a manual which might be used to describe the overall program for the purpose of indoctrinating senior leaders and periodically describing the entire program to the membership at large.

Accordingly, even though the use of such documents might seem to “formalize” what should be personal relationships, it should also be seen that their primary purpose is not to interfere, steer, or direct the nature of such personal relationships but only to provide a methodology and scheduling to facilitate them and to ensure the flow of information within the organization both from the membership to the leadership and back down again. In this manner such information will, with far more frequency than normal, be delivered by a personal source and will be more effective and meaningful.

It has already been discussed how the parameters of the methodology (such as the numbers of persons within the various “circle” groups, the numbers of persons within a given contact chain, and the designation of the various levels or echelons of the program) can be modified to achieve the best possible results. It should also be readily clear that various instructions and procedures will be different from one organization to another, such as the differences between churches, political organizations, or service clubs. These kinds of changes and modifications should all be seen as keeping within the spirit and scope of the present invention.

The elements or requisites of this program can be best described as the following:

1. A basic membership unit or echelon comprising members who are assigned a contact pattern in schedule. The basic membership echelon will have a leader or administrator who will facilitate communication to the next level.

2. One or more organizational supervisory levels or echelons as may be necessary to accommodate all of the membership of a given organization. In a very small organization, such as a new church or mission, the entire supervisory echelons may simply be the primary church staff or even the pastor alone. However, in very large organizations, there may be multiple intermediate echelons.

3. A leadership level or echelon wherein the program will be administered and taught to the membership, with particular emphasis on the responsibilities of each level of membership and supervision throughout. The leadership echelon will also have the responsibility of providing quick and authoritative guidance in response to inquiries and requests for assistance which may come up from the various echelons of the administration of the program.

It is helpful to consider the example of how this method may be practiced in a church congregation. A basic membership unit could be called a “circle” and the intermediate levels could be called “groups”. Manuals could be developed to teach and maintain the method as follows.

Depending upon the complexity of any given organization and upon such other factors as its size and purposes, it may be desirable to provide trailing, literature, and detailed guidance. By way of example but not to be seen as, in anyway, limiting the scope of the invention, an example of such literature is provided herewith in the form of the exhibits numbered one through five.

Exhibit 1 is a manual which describes the overall program. Such a manual would be useful and stating the broad goals, objectives, and strategy of the program as applied to a particular organization, in this case a church congregation.

Exhibit 2 is a manual which would be given to a member of an organization within the basic membership unit, in this case described as a “circle”. In this plan each of the unit members is tasked with the responsibility to reach out to two other members in a circle configuration such as that described in the preferred embodiment. In order to assist them in this task their manual includes such things as pictures and data about the persons they are to reach, general guidance about making contacts, and a log to keep track of their contacts.

Exhibit 3 is a manual which would be given to the leader of the “circle” or of the basic membership unit of this particular organization. Examination of Exhibit 3 also reveals that it includes guidance, the entry of data unique to that particular leader's responsibilities, and records or logs for documenting contacts and making reminders.

Exhibit 4 is a manual which would be given to an intermediate leader. It also includes ways of entering relevant data useful in accomplishing the leadership role at that level, general guidance and direction, and a manner of recording and documenting contacts and activities.

Exhibit 5 is a manual which would be given and taught at the organizational level of leadership and staff. This includes guidance useful in administering the program, monitoring the program, and making adjustments as may be needed to improve efficiency.

When this program is effectively administered it will benefit the organization in many ways. One way would be the goodwill benefits from promoting continuous contacts among members. Another benefit would be the suppression of rumors and misinformation which can seriously damage the integrity of an organization and the confidence of its members. Another benefit would be the promotion of responsive answers to inquiries and to request for an assistance between unit members and between unit members and the organizational leadership. Any organization in which all of the members feel responsible and important and in which their interests are considered and are made a matter of concern by others will be more ineffective than one in which these attributes do not exist.

Several possibilities for tailoring the program as applied to a particular organization are worth mentioning. For instance, a church congregation typically meets weekly and comprises a core of zealous membership and various members with other levels of dedication. Some may be Sunday school teachers or other lay leaders, members of a choir, or members of various church social groups. In such cases it may be wise to assign members representing each kind of constituency to the basic level of membership in order to achieve communications which are likely to include the entire array of church opportunities within each basic unit level of members. On the other hand, it may be that a church or other organization comprises membership groups that are sufficiently divergent that one group would have little or no reason to be concerned about the activities of other membership groups. In those cases it may be wise to designed basic membership units in which these constituencies are kept separate.

In groups or organizations which do not meet regularly or in which there are regular meetings at one level but not at other levels the basic unit membership may be designed in order to keep the less involved unit members apprised of leadership activities and decisions by embedding members of leadership with basic unit members.

While such possibilities are virtually limitless, it should be readily seen that they all fit within the basic pattern of providing a basic membership unit in which unit members are guided to maintain contact with other unit members in a regular pattern on a regular basis which further facilitates reporting, monitoring, effective and cordial communications with and between members and leadership through, an appropriate number of member and leadership levels and ultimately, organizational unity.

The critical decisions are made by the organizational leadership and staff and include the design of the basic membership unit, the regular pattern of communications among the members of the basic membership unit, the number of intermediate levels of leadership and the pattern of communications among the intermediate leaders, in the manner and nature of controls and reporting which will be required by and between each level in order to maintain the desired level of supervision in contact.

Further modification and variation can be made to the disclosed embodiments without departing from the subject and spirit of the invention as defined in the following claims. Such modifications and variations, as included within the scope of these claims, are meant to be considered part of the invention as described.

What is claimed is:

1. A method for facilitating effective communication throughout organizations of various sizes, the method comprising the steps of:
determining an appropriate number of reliable supervisors and leaders available for assignment to positions of responsibility and leadership in the area of maintaining steady and reliable contact with members of said organization;
determining an appropriate number of members for one or more basic communication units in order to facilitate assignment of each member of each basic communication unit the task of maintaining regular contact with one or more other basic communication unit members so that it can be readily ascertained that the desired rate and level of regular contacts among basic communication unit members are being made by a basic communication unit leader;
determining an appropriate number of organizational levels required to facilitate communications among the leaders of various levels
assigning members of an organization to basic communication units, each said basic communication unit further comprising an appropriate number of members each of which are further assigned the responsibility to maintain regular contact with one or more other members of said basic communication unit, each said basic communication unit further up being provided with a primary leader, said primary leader further being assigned the task of maintaining secondary contact with each unit member in regular contact with one or more members of a primary leader unit;
said primary leader unit further comprising two or more primary leaders and a primary leader unit leader, each said primary unit leader further being assigned the task of maintaining regular contact with one or more other primary unit leaders assigned to said primary leader unit and said primary leader unit leader further being assigned the task of maintaining secondary contact with each member of said primary leader in unit in regular contact with a next higher level; and
each said next higher level further comprising one or more primary leader unit leaders, each said primary leader unit leader assigned the task of maintaining contact with one or more other primary leader unit leaders, said next higher unit further comprising a next higher unit leader, said next higher unit leader further being assigned the task of maintaining secondary contact with the members of the next higher unit and regular contact with a leadership level, said leadership level further comprising the organizational leadership and staff.

2. The method described in claim 1 which comprises the additional step of:
developing a training program for the purpose of familiarization of all members and specific guidance and training to leadership at all levels in order to ensure that all personnel within the organization are familiar with the objectives of the program and basic responsibilities and that leaders at all levels are aware of their specific responsibilities with respect to the administration of the program.

3. The method described in claim 1 which comprises the additional step of:
developing and distributing literature for the purpose of providing both general and specific guidance to unit members and leaders at all levels and to facilitate and enhance the program effect of this by providing means for storing data critical to each task and maintaining a log or record of activities taken in support of the program.

4. The method described in claim 1 which comprises the additional steps of:
Developing a training program for the purpose of familiarization of all members and specific guidance and training to leadership at all levels in order to ensure that all personnel within the organization are familiar with the objectives of the program and basic responsibilities and that leaders at all levels are aware of their specific responsibilities with respect to the administration of the program; and
developing and distributing literature for the purpose of providing both general and specific guidance to unit members and leaders at all levels and to facilitate and enhance the program effect of this by providing means for storing data critical to each task and maintaining a log or record of activities taken in support of the program.

5. A method for facilitating effective communication throughout organizations of various sizes, the method comprising the steps of:
determining an appropriate number of reliable supervisors and leaders available for assignment to positions of responsibility and leadership in the area of maintaining steady and reliable contact with members of said organization;
sorting out the membership into logical categories in order to facilitate and to improve the prospects of maintaining successful communications by ensuring the existence of common interests, conditions, or background as a means of enhancing the likelihood of continuous communication among unit members;
determining an appropriate number of members for one or more basic communication units in order to facilitate assignment of each member of each basic communication unit the task of maintaining regular contact with one or more other basic communication unit members so that it can be readily ascertained that the desired rate and level of regular contacts among basic communication unit members are being made by a basic communication unit leader;
determining an appropriate number of organizational levels required to facilitate communications among the leaders of various levels
assigning members of an organization to basic communication units, each said basic communication unit further comprising an appropriate number of members each of which are further assigned the responsibility to maintain regular contact with one or more other members of said basic communication unit, each said basic communication unit further up being provided with a primary leader, said primary leader further being assigned the task of maintaining secondary contact with each unit member in regular contact with one or more members of a primary leader unit;
said primary leader unit further comprising two or more primary leaders and a primary leader unit leader, each said primary unit leader further being assigned the task of maintaining regular contact with one or more other primary unit leaders assigned to said primary leader unit and said primary leader unit leader further being assigned the task of maintaining secondary contact with each member of said primary leader in unit in regular contact with a next higher level;
each said next higher level further comprising one or more primary leader unit leaders, each said primary leader unit leader assigned the task of maintaining contact with one or more other primary leader unit leaders, said next higher unit further comprising a next higher unit leader, said next higher unit leader further being assigned the task of maintaining secondary contact with the members of the next higher unit and regular contact with a leadership level, said leadership level further comprising the organizational leadership and staff.

6. The method described in claim 5 which comprises the additional step of:
developing a training program for the purpose of familiarization of all members and specific guidance and training to leadership at all levels in order to ensure that all personnel within the organization are familiar with the objectives of the program and basic responsibilities and that leaders at all levels are aware of their specific responsibilities with respect to the administration of the program.

7. The method described in claim 5 which comprises the additional step of:
developing and distributing literature for the purpose of providing both general and specific guidance to unit members and leaders at all levels and to facilitate and enhance the program effect of this by providing means for storing data critical to each task and maintaining a log or record of activities taken in support of the program.

8. The method described in claim 5 which comprises the additional steps of:
Developing a training program for the purpose of familiarization of all members and specific guidance and training to leadership at all levels in order to ensure that all personnel within the organization are familiar with the objectives of the program and basic responsibilities and that leaders at all levels are aware of their specific responsibilities with respect to the administration of the program; and
developing and distributing literature for the purpose of providing both general and specific guidance to unit members and leaders at all levels and to facilitate and enhance the program effect of this by providing means for storing data critical to each task and maintaining a log or record of activities taken in support of the program.

9. A method for facilitating effective communication throughout organizations of various sizes, the method comprising the steps of:
determining an appropriate number of reliable supervisors and leaders available for assignment to positions of responsibility and leadership in the area of maintaining steady and reliable contact with members of said organization;
dividing the membership into basic membership units which ensure a disparity of common interest, conditions, or background as a means of enhancing the likelihood that unit members will become familiar with all of the aspects of organizational goals, objectives, opportunities, and activities;
determining an appropriate number of members for one or more basic communication units in order to facilitate assignment of each member of each basic communication unit the task of maintaining regular contact with one or more other basic communication unit members so that it can be readily ascertained that the desired rate and level of regular contacts among basic communication unit members are being made by a basic communication unit leader;
determining an appropriate number of organizational levels required to facilitate communications among the leaders of various levels
assigning members of an organization to basic communication units, each said basic communication unit further comprising an appropriate number of members each of which are further assigned the responsibility to maintain regular contact with one or more other members of said basic communication unit, each said basic communication unit further up being provided with a primary leader, said primary leader further being assigned the task of maintaining secondary contact with each unit member in regular contact with one or more members of a primary leader unit;
said primary leader unit further comprising two or more primary leaders and a primary leader unit leader, each said primary unit leader further being assigned the task of maintaining regular contact with one or more other primary unit leaders assigned to said primary leader unit and said primary leader unit leader further being assigned the task of maintaining secondary contact with each member of said primary leader in unit in regular contact with a next higher level;
each said next higher level further comprising one or more primary leader unit leaders, each said primary leader unit leader assigned the task of maintaining contact with one or more other primary leader unit leaders, said next higher unit further comprising a next higher unit leader, said next higher unit leader further being assigned the task of maintaining secondary contact with the members of the next higher unit and regular contact with a leadership level, said leadership level further comprising the organizational leadership and staff.

10. The method described in claim 9 which comprises the additional step of:
developing a training program for the purpose of familiarization of all members and specific guidance and training to leadership at all levels in order to ensure that all personnel within the organization are familiar with the objectives of the program and basic responsibilities and that leaders at all levels are aware of their specific responsibilities with respect to the administration of the program.

11. The method described in claim 9 which comprises the additional step of:
developing and distributing literature for the purpose of providing both general and specific guidance to unit members and leaders at all levels and to facilitate and enhance the program effect of this by providing means for storing data critical to each task and maintaining a log or record of activities taken in support of the program.

12. The method described in claim 9 which comprises the additional steps of:
Developing a training program for the purpose of familiarization of all members and specific guidance and trailing to leadership at all levels in order to ensure that all personnel within the organization are familiar with the objectives of the program and basic responsibilities and that leaders at all levels are aware of their specific responsibilities with respect to the administration of the program; and
developing and distributing literature for the purpose of providing both general and specific guidance to unit members and leaders at all levels and to facilitate and enhance the program effect of this by providing means for storing data critical to each task and maintaining a log or record of activities taken in support of the program.
